(19) United States
(12) Patent Application Publication
(10) Pub. No.: US 2025/0190099 A1
(43) Pub. Date: Jun. 12, 2025

(54) CREATING TEXT BLOCK SECTIONS

(71) Applicant: MYSCRIPT, Nantes Cedex 3 (FR)

(72) Inventors: Thibault DESCHAMPS, Nantes Cedex 3 (FR); Gregory COUSIN, Nantes Cedex 3 (FR)

(21) Appl. No.: 18/846,109

(22) PCT Filed: Mar. 13, 2023
(86) PCT No.: PCT/EP2023/056287

§ 371 Date: Sep. 11, 2024

(30) Foreign Application Priority Data
Mar. 11, 2022 (EP) 22161588.3

(51) Int. Cl. G06F 3/04842; G06F 3/0486; G06F 3/0488

(52) U.S. Cl. CPC G06F 3/04842; G06F 3/0486; G06F 3/0488

(57) ABSTRACT

Methods and devices for creating block sections are disclosed. On a display, an initial text block section (enclosing input elements are displayed. On an input interface, user selection gestures defining selection areas enclosing input elements of the initial text block sections are detected. Enclosed input elements within the initial text block sections are selected. User dragging gestures for moving the selected input elements from the initial text block sections to locations positioned outside the initial text block sections are detected. Finally, new text block sections are created enclosing the selected input elements.

### FIELD OF THE INVENTION

The present disclosure relates generally to the field of computing device interfaces capable of interacting with, editing block sections, and handwriting recognition. In particular, the present disclosure relates to editing and creating block sections.

### BACKGROUND

Computing devices continue to become more ubiquitous to daily life. They take the form of computer desktops, laptop computers, tablet computers, hybrid computers (2-in-1s), e-book readers, mobile phones, smartphones, wearable computers (including smartwatches, smart glasses/headsets), global positioning system (GPS) units, enterprise digital assistants (EDAs), personal digital assistants (PDAs), game consoles, and the like. Further, computing devices are being incorporated into vehicles and equipment, such as cars, trucks, farm equipment, manufacturing equipment, building environment control (e.g., lighting, HVAC), and home and commercial appliances.

Computing devices generally comprise at least one processing element, such as a central processing unit (CPU), some form of memory, and input and output devices. The variety of computing devices and their subsequent uses necessitate a variety of interfaces and input devices. One such input device is a touch sensitive surface such as a touch screen or touch pad wherein user input is received through contact between the user's finger or an instrument such as a pen or stylus and the touch sensitive surface. Another input device is an input surface that senses gestures made by a user above the input surface. A further input device is a position detection system which detects the relative position of either touch or non-touch interactions with a non-touch physical or virtual surface. Any of these methods of input can be used generally for drawing or inputting text. The user's handwriting is interpreted using a handwriting recognition system or method.

There are many applications of handwriting recognition in portable computing devices, such as smartphones, phablets and tablets, such as is in note taking, document annotation, mathematical equation input and calculation, music symbol input, sketching and drawing, etc. Handwriting may also be input to non-portable computing devices, particularly with the increasing availability of touchscreen monitors for desktop computers and interactive whiteboards. These types of input are usually performed by the user launching a handwriting input application on the computing device which accepts and interprets, either locally in the device or remotely via a communications link of the device, handwritten input on the touch sensitive surface and displays or otherwise renders this input as so-called ‘digital ink’. Conventionally such handwriting input applications are limited in their capabilities to provide a full document creation experience to users from the text and non-text (e.g., drawings, equations), since the focus of these applications has primarily been recognition accuracy rather than document creation.

Handwriting recognition can be implemented in computing devices to receive as input, and process, various types of graphical objects (also called input elements), hand-drawn or handwritten by a user, such as text content (e.g., alphanumeric characters) or non-text content (e.g. shapes, drawings).

Once inputted on a computing device, the input elements are usually displayed as digital ink and undergo handwriting recognition to be converted into typeset versions. The user handwriting input is typically interpreted using a real-time handwriting recognition system or method. To this end, either on-line systems (recognition carried out using a cloud-based solution or the like) or off-line systems may be used.

The user input may be drawings, diagrams or any other content of text, non-text or mixed content of text and non-text. Handwriting input may be made on a structured document according to guiding lines (base lines) which guide and constraint input by the user. Alternatively, a user may handwrite in free-mode, i.e. without any constraints of lines to follow or input size to comply with (e.g. on a blank page).

In handwriting recognition applications, it is usually possible to perform some level of editing on user input displayed on a computing device.

The user may need to edit the text block sections extracted from the handwriting input text, for example in the context of notetaking wherein multiple handwriting inputs displayed within one text block section may be contextually inconsistent.

Conventionally, such applications are however limited in their capabilities to handle editing functions and typically constrain users to adopt behaviors or accept compromises which do not reflect the user's original intent. As a result, some conventional handwritten recognition applications force users to navigate menus to select and edit ink elements.

The Applicant has found that when using handwriting applications, users generally are unable or do not desire to learn specific gestures that are not natural or intuitive, or to make editing selections through menus and the like.

Typically, the ability in conventional handwriting recognition applications to rearrange text or non-text ink input elements is limited where only certain operations are available, often involving complex or unnatural manipulations by the users. As such, it is generally difficult for users to edit text or non-text context in an ergonomic and efficient manner. These limitations and deficiencies result especially from the fact that the user interface and the associated user manipulations are usually not (or poorly) adapted to the ergonomics, anatomy or physical constraints of the users.

In particular, when various graphical objects are displayed on a screen, it is often physically difficult for a user to select graphical objects, for the purpose of editing for instance. Computing devices running handwriting recognition applications generally does not permit easy and intuitive selection of graphical objects. It is thus fastidious for users to manipulate text and non-text content displayed on a screen.

Improvements are desired to allow easy and intuitive selection of graphical objects (either text and/or non-text) on a computing device.

### SUMMARY OF THE INVENTION

The present invention involves using a computing device to display input elements in various sections of a display area, and select content contained (partially or totally) in the selection area defined by the user selection gesture for creating new sections of the display. More particularly, this selection area is formed by a selection path defined by the user selection gesture. Further aspects of the present invention will be described hereafter.

According to a first aspect, the invention provides a method implemented by the computing device comprising: displaying, on the display, an initial text block section; detecting, with (or on) an input interface, a user selection gesture defining a selection area enclosing at least one input element of the initial text block section; selecting the at least one enclosed input element positioned at a first initial location within the initial text block section; detecting, with (or on) the input interface, a user dragging gesture for moving the at least one selected input element from the initial block section to a final location positioned outside the initial text block section; creating the new text block section at the final position enclosing the at least one selected input element.

According to a particular embodiment, the initial text block section including input elements is a text block.

According to a particular embodiment, the at least one input element is a text element such as a character, a word or a text line.

According to a particular embodiment, the at least one input element is a handwriting input element.

According to a particular embodiment, the adjusting of the initial text block section, at a first static initial position, encloses at least one first unselected input element of the initial text block section.

According to a particular embodiment, the creating of a subsequent block section, at a second static initial position, encloses at least one second unselected input element of the initial text block section.

According to a particular embodiment, the at least one selected input element includes text lines whereby the selected text lines are aligned with a border of the new block section.

According to a particular embodiment, the first or second unselected elements include text lines whereby the first or second unselected elements are aligned with a border of the initial and the subsequent new block section, respectively.

According to a particular embodiment, the method comprises recognizing the handwritten input elements wherein the input elements enclosed in the initial text block section are handwritten input.

According to a particular embodiment, the method comprises in response to the creating of the new text block section: re-recognizing the handwritten input elements including the at least one selected input element and the at least first and second unselected input element.

According to a particular embodiment, the at least one selected input element and the at least first and second unselected input element are converted as typeset.

According to a particular embodiment, the selection area encloses an image.

According to a particular embodiment, the selection area encloses at least one non-text stroke.

According to a particular embodiment, the at least one selected input element is a cursor.

According to a particular embodiment, the initial text block is resulting from performing text block extraction from strokes of the handwriting input element displayed on the display area, said text block extraction comprising identifying text and non-text strokes and grouping the strokes into the initial block according to different hypotheses.

According to a second aspect, the invention provides a computer readable program code (or computer program) including instructions for executing the steps of the method of the first aspect of the invention. This computer program may be stored on a recording medium and executable by a computing device, and more generally by a processor, this computer program comprising instructions adapted for the implementation of the method of the first aspect.

The computer program of the invention can be expressed in any programming language, and can be in the form of source code, object code, or any intermediary code between source code and object code, such that in a partially-compiled form, for instance, or in any other appropriate form.

According to a third aspect, the invention provides a non-transitory computer readable medium having a computer program of the second aspect recorded therein. This non-transitory computer readable medium can be any entity or device capable of storing the computer program. For example, the recording medium can comprise a storing means, such as a ROM memory (a CD-ROM or a ROM implemented in a microelectronic circuit), or a magnetic storing means such as a floppy disk or a hard disk for instance.

The non-transitory computer readable medium of the invention can correspond to a transmittable medium, such as an electrical or an optical signal, which can be conveyed via an electric or an optic cable, or by radio or any other appropriate means. The computer program according to the disclosure can in particular be downloaded from the Internet or a network of the like.

Alternatively, the non-transitory computer readable medium can correspond to an integrated circuit in which a computer program is loaded, the circuit being adapted to execute or to be used in the execution of the methods of the invention.

According to a fourth aspect, the present invention relates to a computing device for creating a new text block section enclosing input elements obtained from an initial text block section, comprising: a display area configured to display the initial text block section and the new text block section; an input area configured to detect: a user selection gesture defining a selection area enclosing at least one input element of the initial text block section, and a user dragging gesture for moving the at least one selected input element from the initial text block section to a final location positioned outside the initial text block section; an input selection module configured to select the at least one enclosed input element positioned at a first initial location within the initial text block section; a displacing module configured to move the at least one selected input element from the initial location to a final location positioned outside the initial text block section; a new block creation module configured to create the new text block section at the final position enclosing the at least one selected input element.

The various embodiments defined above in connection with the method of the first aspect apply in an analogous manner to the computing device, the computer program and the non-transitory computer readable medium of the present invention.

For each step (or operation) of the method of the first aspect of the present invention, the computing device of the fourth aspect may comprise a corresponding module configured to perform said step (or operation).

According to other embodiments, the computing device further comprises: an initial block adjusting module configured to adjust the initial block section, at a first static initial position, to enclose at least one first unselected input element of the initial text block section; a subsequent block creation module configured to create a subsequent block section, at a second static initial position, to enclose at least one second unselected input element of the initial text block section.

Where functional modules are referred to in the present disclosure for carrying out various steps of the described method(s) it will be understood that these modules may be implemented in hardware, in software, or a combination of the two. When implemented in hardware, the modules may be implemented as one or more hardware modules, such as one or more application specific integrated circuits. When implemented in software, the modules may be implemented as one or more computer programs that are executed on one or more processors.

### BRIEF DESCRIPTION OF THE DRAWINGS

The present system and method will be more fully understood from the following detailed description of the examples thereof, taken together with the drawings. In the drawings like reference numerals depict like elements. In the drawings:

FIG. 1 shows a block diagram of a computing device in accordance with an embodiment of the present invention;

FIG. 2A shows a text block example including a user selection gesture of input elements of an initial block section according to an embodiment of the present invention;

FIG. 2B shows text block creation example including a moving selection gesture of selected input elements according to an embodiment of the present invention;

FIG. 2C shows a new text block displacement process on a computing device according to an embodiment of the present invention;

FIG. 2D shows resulting text blocks created according to an embodiment of the present invention;

FIG. 3A shows a text block example including a user selection gesture of a cursor according to an embodiment of the present invention;

FIG. 3B shows text block creation example including a moving selection gesture of a cursor according to a moving gesture of the present invention;

FIG. 3C shows resulting text blocks according to an embodiment of the present invention;

FIG. 4A shows a text block example including a user selection gesture of input elements of an initial block section according to an embodiment of the present invention;

FIG. 4B shows text block creation example including a moving selection gesture of selected input elements according to a moving gesture of the present invention;

FIG. 4C shows resulting text blocks according to an embodiment of the present invention;

FIG. 5A shows a text block and non-text items including a user selection gesture of strokes and input elements of an initial block section according to an embodiment of the present invention;

FIG. 5B shows text block creation example including a moving selection gesture of input elements and selected strokes according to a moving gesture of the present invention;

FIG. 5C shows creation of new text blocks according to an embodiment of the present invention;

FIG. 6 shows a flow diagram of an example of the present method for creating a new text block section enclosing input elements obtained from an initial text block section.

FIG. 7A shows a text block example including handwritten input elements and a user selection gesture of input elements of an initial block section according to an embodiment of the present invention;

FIG. 7B shows text block creation example including handwritten input elements and a moving selection gesture of selected input elements according to a moving gesture of the present invention;

FIG. 7C shows resulting text blocks including handwritten input elements according to an embodiment of the present invention.

### DETAILED DESCRIPTION OF EXAMPLE EMBODIMENTS

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high- level, without detail, in order to avoid unnecessarily obscuring aspects of the present teachings.

Reference to and discussion of directional features such as up, down, above, below, lowest, highest, horizontal, vertical, etc., are made with respect to the Cartesian coordinate system as applied to the input interface on which the input to be recognized is made. Further, the use of the term ‘text’ in the present description is understood as encompassing all alphanumeric characters, and strings thereof, in any written language and common place non-alphanumeric characters, e.g., symbols, used in written text.

The term “non-text” in the present description is understood as encompassing freeform handwritten or hand-drawn content (e.g. shapes, drawings, etc.) and image data, as well as characters, and string thereof, or symbols which are used in non-text contexts. Non-text content defines graphic or geometric formations in linear or non-linear configurations, including containers, drawings, common shapes (e.g. arrows, blocks, etc.) or the like. In unconstrained canvas for instance, text content may be contained in containers or shapes (a rectangle, ellipse, oval shape . . . ).

The systems and methods described herein may utilize recognition of users' natural writing or drawing styles input to a computing device via an input interface, such as a touch sensitive screen, connected to, or of, the computing device or via an input device, such as a digital pen or mouse, connected to the computing device. Whilst the various examples are described with respect to recognition of handwriting input using so-called online recognition techniques, it is understood that application is possible to other forms of input for recognition, such as offline recognition in which images rather than digital ink are recognized.

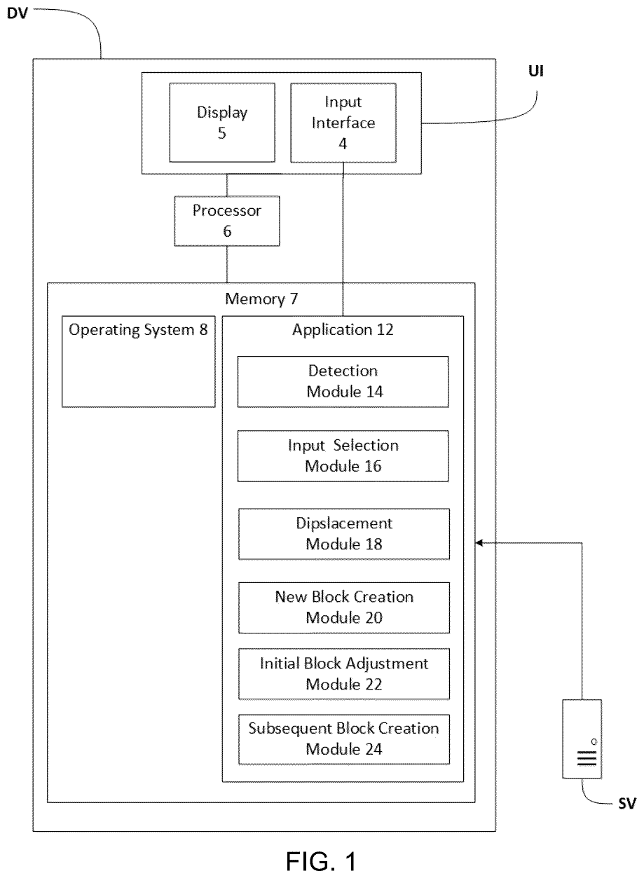

FIG. 1 illustrates a block diagram of a system, comprising a computing device DV, for creating, on a display, block sections (also called blocks) or containers enclosing one or a plurality of input elements obtained from an initial block section located at an initial block position of the display.

The computing device DV may be a computer desktop, laptop computer, tablet computer, hybrid computers (2-in-1 s), e-book reader, mobile phone, smartphone, wearable computer, digital watch, interactive whiteboard, global positioning system (GPS) unit, enterprise digital assistant (EDA), personal digital assistant (PDA), game console, or the like. The computing device DV includes components of at least one processing element, some form of memory and input and/or output (I/O) devices. The components communicate with each other through inputs and outputs, such as connectors, lines, buses, cables, buffers, electromagnetic links, networks, modems, transducers, IR ports, antennas, or others known to those of ordinary skill in the art.

In the illustrated example, the computing device DV comprises at least one display 5 for outputting data from the computing device such as images, text, and video. The display 5 may use LCD, plasma, LED, OLED, CRT, or any other appropriate technology that is or is not touch sensitive as known to those of ordinary skill in the art. At least some part of the display 5 may be co-located with at least one input area (or input surface, or input interface) 4. The input area 4 may employ technology such as resistive, surface acoustic wave, capacitive, infrared grid, infrared acrylic projection, optical imaging, dispersive signal technology, acoustic pulse recognition, or any other appropriate technology as known to those of ordinary skill in the art to receive user input in the form of a touch-or proximity-sensitive surface. The input area 4 may be a non-touch sensitive surface which is monitored by a position detection system. The input area 4 may be bounded by a permanent or video-generated border that clearly identifies its boundaries. Instead of, or additional to, an on-board display, the computing device DV may have a projected display capability.

The computing device DV also includes a processor 6, which is a hardware device for executing software, particularly software stored in memory 7. The processor 6 can be any custom made or commercially available general purpose processor, a central processing unit (CPU), commercially available microprocessors including a semiconductor based microprocessor (in the form of a microchip or chipset), microcontroller, digital signal processor (DSP), application specific integrated circuit (ASIC), field programmable gate array (FPGA) or other programmable logic device, discrete gate or transistor logic, discrete hardware components, state machine, or any combination thereof designed for executing software instructions known to those of ordinary skill in the art.

The memory 7 can include any one or a combination of volatile memory elements (e.g., random access memory (RAM, such as DRAM, SRAM, or SDRAM)) and nonvolatile memory elements (e.g., ROM, EPROM, flash PROM, EEPROM, hard drive, magnetic or optical tape, memory registers, CD-ROM, WORM, DVD, redundant array of inexpensive disks (RAID), another direct access storage device (DASD), or any other magnetic, resistive or phase-change nonvolatile memory). Moreover, the memory 7 may incorporate electronic, magnetic, optical, and/or other types of storage media. The memory 7 can have a distributed architecture where various components are situated remote from one another but can also be accessed by the processor 6. Further, the memory 7 may be remote from the device DV, such as at a server or cloud-based system, which is remotely accessible by the computing device DV.

The memory 7 is coupled to the processor 6, thereby enabling the processor 6 to read information from, and write information to, the memory 7. In the alternative, the memory 7 may be integral to the processor 6. In another example, the processor 6 and the memory 7 may both reside in a single ASIC or other integrated circuit.

The software in the memory 7 includes an operating system 8 and an application 12 in the form of a non-transitory computer readable medium having a computer readable program code (or computer program) embodied therein. The operating system 8 controls the execution of the application 12. The operating system 8 may be any proprietary operating system or a commercially or freely available operating system, such as WEBOS, WINDOWS®, MAC and IPHONE OS®, LINUX, and ANDROID. It is understood that other operating systems may also be utilized. Alternatively, the application 12 of the present system and method may be provided without use of an operating system.

The application 12 includes one or more processing elements related to detection, management and treatment of user input (discussed in detail later). In particular, the application 12 may comprise instructions for executing a method of the invention, as described further below in particular embodiments.

The software may also include one or more other applications related to handwriting recognition (HWR), different functions, or both. Some examples of other applications include a text editor, telephone dialer, contacts directory, instant messaging facility, computer-aided design (CAD) program, email program, word processing program, web browser, and camera.

The application 12, with support and compliance capabilities, may be a source program, executable program (object code), script, application, or any other entity having a set of instructions to be performed. When a source program, the program needs to be translated via a compiler, assembler, interpreter, or the like, which may or may not be included within the memory, so as to operate properly in connection with the operating system. Furthermore, the HWR system with support and compliance capabilities can be written as (a) an object oriented programming language, which has classes of data and methods; (b) a procedure programming language, which has routines, subroutines, and/or functions, for example but not limited to C, C++, Pascal, Basic, Fortran, Cobol, Perl, Java, Objective C, Swift, and Ada; or (c) functional programing languages for example but no limited to Hope, Rex, Common Lisp, Scheme, Clojure, Racket, Erlang, OCaml, Haskell, Prolog, and F#.

Handwriting input entered on or via the input area 4 may be processed by the processor 6 as digital ink. A user may enter a handwriting input with a finger or some instrument such as a pen or stylus suitable for use with the input interface 4. The user may also enter a handwriting input by making a gesture above the input interface 4 if technology that senses or images motion in the vicinity of the input interface 4 is being used, or with a peripheral device of the computing device DV, such as a mouse or joystick, or with a projected interface, e.g., image processing of a passive plane surface to determine the stroke and gesture signals.

In a particular example, the system and method of the present invention allow handwriting to be input virtually anywhere on the input area 4 of the computing device DV and this input may be rendered as digital ink in the input position on the display area 5. The input area 4 may be provided as an unconstrained canvas that allows users to create object blocks (blocks of text, drawings, etc.) anywhere without worrying about sizing or alignment. However, an alignment structure in the form of a line pattern background may be provided for guidance of user input and the alignment of digital and typeset ink objects. In any case, as users may input handwriting that is not closely aligned to the line pattern or may desire to ignore the line pattern and write in an unconstrained manner, such as diagonally or haphazardly, the HWR system is able to recognize this freely positioned handwriting. This ‘free’ input may be rendered as digital ink at the input position.

Various types of graphical objects can be processed by the computing devices, referred to in the present disclosure as the input elements, such as text content (e.g., alphanumeric characters) or non-text content (e.g. shapes, drawings). On the computing device, the input elements can be typeset from a keyboard, hand-drawn or handwritten from a pen or a finger by a user. The input elements can be displayed as digital ink or typeset version.

A handwriting input is formed of (or comprises) one or plural strokes. Each stroke is characterized by at least a stroke initiation location, a stroke termination location, and a path connecting the stroke initiation and termination locations. Further information such as timing, pressure, angle at a number of sample points along the path may also be captured to provide deeper detail of the strokes.

More specifically, the computing device DV may be configured to group strokes of digital ink into blocks of one or more strokes, each block being either a text block or non-text block. Each stroke contained in a text block may be a part of a text symbol.

This grouping allows generating or combining the strokes into coherent single blocks, as text blocks or non-text blocks. Different strategies may be implemented to aggregate classification results for each stroke. The generation of blocks may also be based on other predefined constraints such as stroke level constraints, spatial constraints, etc. to make it more comprehensible, robust and useful for subsequent recognition. In a particular example, these constraints may comprise any one (or all) of the following: overlapping strokes are grouped into a single block; the strokes are grouped into horizontally spaced blocks; a threshold is set for minimum and/or maximum strokes per block (to remove noise), etc.

In a particular example, the computing device DV is configured to perform handwriting recognition including a text block extraction to extract text blocks from strokes of digital ink of the handwritten input text.

In a particular example, accurately detecting and identifying the type of content is a first step in a recognition of the text content. Disambiguating between text and non-text content is one step whereas another step is the accurate extraction of text blocks.

In a particular example, the computing device DV may be configured to apply, to a page of strokes of digital ink, a two-step process to identify and output text blocks. As a first step of this two-step process, a text versus non-text classification may be performed to attribute a label to each stroke indicating if it's a textual stroke or a non-textual stroke. Text strokes aims to be recognized and transcribed at some point. The non-textual strokes are actually any other strokes that do correspond to text. The non-textual strokes can be any type of strokes, such as drawings, table structures, recognizable shapes, etc.

Once the text strokes have been identified, then, as a second step of this two-step process, the text strokes are gathered (grouped) into text blocks. A text block is the input entity of the text recognition process performed by a text recognizer. A page can contain several text blocks without any prior assumption on their layout in the page.

The text block extraction (TBE) process may receive as input a set of text strokes and a set of non-text strokes in a same page of content and outputs a set of text block tags (one for each text block detected in the page).

Particular exemplary embodiments of this TBE are now described hereafter for illustrative purpose only.

The TBE is a sequential gathering process and can be considered as a bottom-up approach: it starts from the smallest entities (the strokes) and gathers (groups) them until having the biggest entities (the text blocks).

In a particular example, the TBE sequence comprises the following:
i) temporally gathering strokes into word hypotheses;
ii) temporally gathering words into text line hypotheses;
iii) spatially gathering text lines to create text block hypotheses;
iv) inside text blocks, merging spatially some text line hypotheses; and
v) iterating steps 3 and 4 until the number of text line is steady.

More specifically, the step of temporally gathering strokes into word hypotheses may use a dynamic programming algorithm to temporally combine strokes into hypotheses and select at the end the best set of word hypothesis in the input stroke sequence i.e. the set of words that minimizes a cost. The aim of the dynamic programming algorithm is to test all possible hypothesis creation in the input stroke sequence. It means that the strokes need to be ordered to have a sequence as the input. The natural order is to use the temporal one: the order of creation of the strokes.

To evaluate each hypothesis, a cost function may be defined that has a low value for the good word hypotheses and high values for bad ones. One such cost function that may be used for this step only relies on the standard deviation of Y coordinates of stroke points relative to a global text scale estimated on the set of text strokes in the page.

Some rules may also be used to discard certain hypotheses. One such rule is based on the X (horizontal) distance and the Y (vertical) distances between strokes in a hypothesis that must be under a predefined horizontal or vertical threshold, respectively (the vertical and horizontal thresholds are factors of the global text scale).

Another factor to create the word hypotheses may be the presence of non-textual strokes. The non-textual strokes may cut (or stop) a word hypothesis creation. For example, in a freeform handwriting mode, if a non-text stroke is detected between two text strokes, then any corresponding word hypotheses are discarded.

At the end of this step, a sequence of words may be temporally ordered. To temporally gather words into text line hypotheses a dynamic programming algorithm may also be used to combine words from the word sequence into text lines hypotheses. This allows to create the biggest text lines containing words written in a perfect temporal order.

In one example, the cost function defining what is a good temporal text line hypothesis may involve one or any combination of the following four sub costs:
i) a standard deviation of point Y coordinates around an estimated height of text with the aim to maintain the deviation close to zero while gathering strokes that are horizontally aligned (for the Y coordinates that are span globally in the same range) and that grows quickly in case of line breaks.
ii) an extrema overflow cost that corresponds to the way strokes in a word hypothesis share a close height, penalizing a hypothesis that contains too big outliers
iii) a horizontal gap cost between strokes inside a hypothesis where the cost increases with the size of the maximum horizontal gap in the hypothesis
iv) a size cost around a global text scale avoiding too small hypotheses

Presence of non-textual strokes can also allow discarding some hypotheses. If a non-text stroke is found in between two words, then those two words can't be considered as belonging in the same text line hypothesis. At the end of this step, a set of text lines with a coherent writing order is produced.

A post processing may take place at this stage to try to merge obvious temporal hypotheses and have better text line hypotheses for the next step. After a spatial ordering of the text line hypotheses, hypotheses that are well aligned horizontally may be merged, assuming that there is no non-text stroke in between them and that they are not too far horizontally relative to each other.

To spatially gather text lines to create text block hypotheses again a dynamic programming approach may be used to gather line hypothesis in the most coherent text block set regarding a cost function. But this time the temporal order is ignored and instead the text line hypothesis are ordered vertically. The value used to order the text line is the vertical position of the baseline. Iteratively, the algorithm will try to add a new text line in several sets of text blocks. For computation efficiency, not all possible text block sets are kept but only the ones that have the lower cost, e.g. the ten best ones. While trying to add a new text line, the algorithm attempts to add it in each text block hypothesis of each text block set available and also attempts to add this new text line as a new single line text block in each set.

In a particular example, the computing device DV is configured to detect and display the handwritten input text which is input using the input interface 4, for instance in a free handwriting format (or free handwriting mode) which affords complete freedom to the user during handwriting input, this being sometimes desirable for instance to take quick and miscellaneous notes or make mixed input of text and non-text. In the following examples, it is assumed for illustrative purpose only that the text handwriting is input in the free handwriting mode (or format) as described above, although other embodiments are possible where the free mode is not used for handwriting input.

The display 5 of the computing device DV is configured to display, in a display area (or input area 4), text handwriting formed by a plurality of strokes (or input strokes) of digital ink. In the examples described hereafter, it is assumed for illustrative purpose only that the detected strokes are input along (or substantially along) a same handwriting orientation X (e.g. the horizontal orientation in the present case). Variations of handwriting orientations, e.g. deviations from an intended orientation within the same line, may however be possible in some cases. Text handwriting may of course take many different forms and styles, depending on each case.

In a particular example, the computing device DV is configured to display strokes within (or as part of) boxes, these boxes being representative of the respective block(s) to which each stroke belongs.

The present system and method may further allow users to interact with the digital ink itself and provide meaningful guidance and results of that interaction. Interaction is assisted by the performance of segmentation of strokes in the recognition process and using information on this segmentation to allow management of an input or editing cursor that acts as a pointer for character level interactions and editing operations.

As previously indicated, the software in memory 7 (FIG. 1) may comprise one or more applications or functions related to HWR. Exemplary implementations of a HWR system are described hereafter for illustrative purpose only.

In a particular example, the HWR system includes stages (and corresponding modules) such as preprocessing, recognition and output. The preprocessing stage may processe the digital ink to achieve greater accuracy and reducing processing time during the recognition stage. This preprocessing may include normalizing of the path connecting the stroke initiation and termination locations by applying size normalization and/or methods such as B-spline approximation to smooth the input. The preprocessed strokes may then be passed to the recognition stage which processes the strokes to recognize the objects formed thereby. The recognized objects may then be output to the display 5 as a digital ink or typeset ink versions of the handwritten input.

The recognition stage may include different processing elements or experts. Three expert systems, a segmentation expert system, a recognition expert system, and a language expert system, collaborate through dynamic programming to generate the output. An expert system is a computer system emulating the decision-making ability of a human expert. Expert systems are designed to solve complex problems by reasoning through bodies of knowledge, represented mainly as if-then rules rather than through conventional procedural programming.

Some aspects of these experts are described here below for illustrative purpose only to facilitate understanding of the present invention. However, no further detail is provided to avoid unnecessarily obscuring the present disclosure. Details of implementing handwriting recognition can for instance be found in EP patent application N° 1 836 651 A1.

The segmentation expert defines the different ways to segment the input strokes into individual element hypotheses, e.g., alphanumeric characters and mathematical operators, text characters, individual shapes, or sub expression, in order to form expressions, e.g., words, mathematical equations, or groups of shapes.

For example, the segmentation expert may form the element hypotheses by grouping consecutive strokes of the original input to obtain a segmentation graph where each node corresponds to at least one element hypothesis and where adjacency constraints between elements are handled by the node connections.

Alternatively, the segmentation expert may employ separate experts for different text or non-text input, such as characters, drawings, equations, and music notation.

To this end, the segmentation expert may process the plurality of ink points into a plurality of segments each corresponding to a respective sub-stroke of the stroke represented by the original input. Each sub-stroke comprises a respective subset of the plurality of ink points representing the stroke.

The insight behind sub-stroke segmentation is to obtain a sequential representation that follows the path of the stroke. Each segment corresponds as such to a local description of the stroke. Compared to representing the stroke as a mere sequence of points, sub-stroke segmentation permits to maintain path information (i.e., the relationships between points within each segment) which results in a reduction in computation time.

Different sub-stroke segmentation techniques may be used according to embodiments. In an embodiment, sub-stroke segmentation based on temporal information is used, resulting in the plurality of segments having equal duration. In an embodiment, the same segment duration is used for all strokes. Further, the segment duration may be device independent.

The recognition expert associates a list of word candidates with probabilities or recognition scores for each node of the segmentation graph. These probabilities or recognition scores are based on language information. The language information defines all the different characters and words of the specified language.

The language expert generates linguistic meaning for the different paths in the segmentation graph using language models (e.g., grammar or semantics). The expert checks the candidates suggested by the other experts according to linguistic information. The linguistic information can include a lexicon, regular expressions, etc. and is the storage for all static data used by the language expert to execute a language model. A language model can rely on statistical information on a given language.

According to a particular embodiment, when running the applications 12 stored in the memory 7 (FIG. 1), the processor 6 is configured to implement modules, namely: a detection module 14, an input selection module 16, a displacement module 18, a block creation module 20, and also possibly an initial block adjustment module 22 and/or a subsequent block creation module 24. Particular implementations of these modules are described hereafter by way of examples.

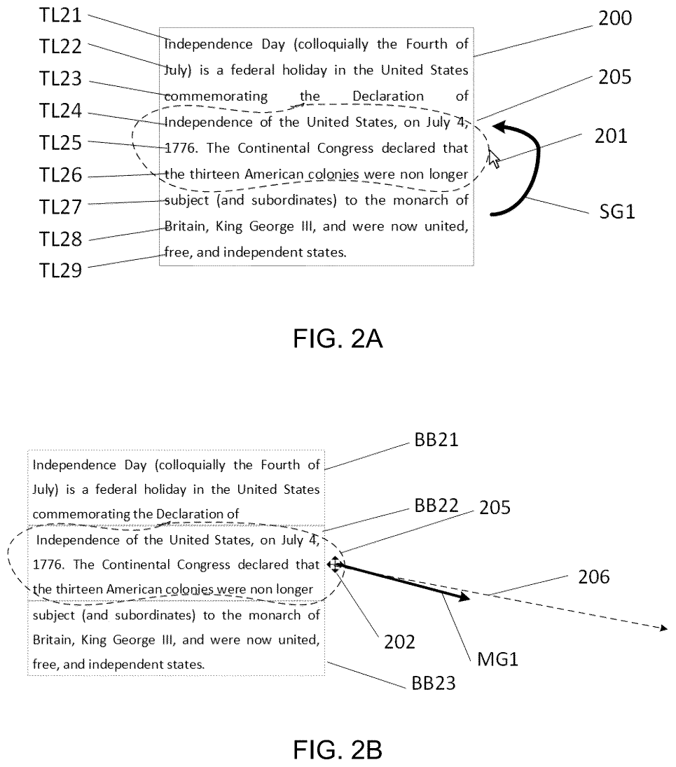

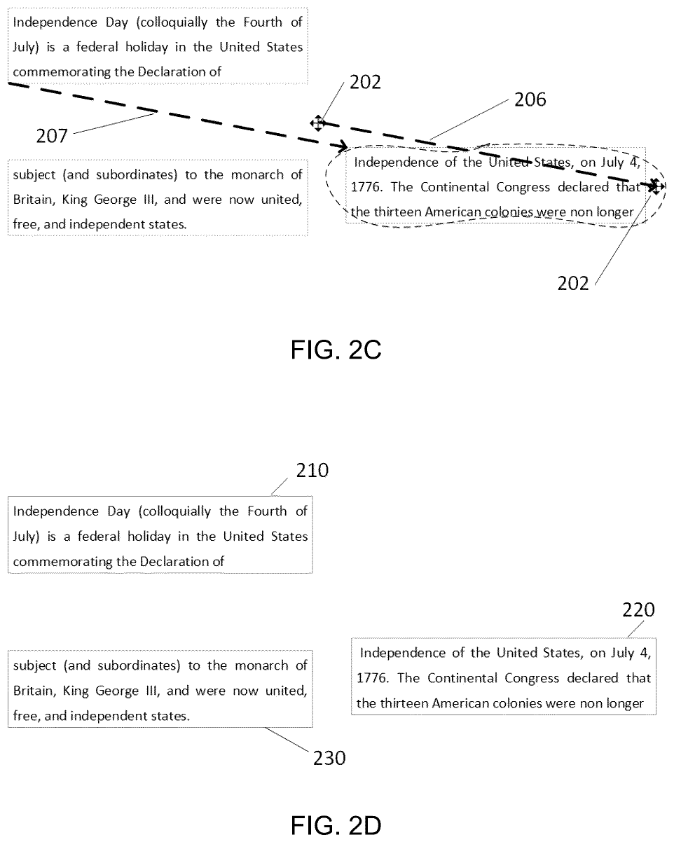

The detection module 14 is configured to detect, with (or on) the input surface 4, a selection gesture (SG2, FIG. 2B) which defines a selection area (or selection zone) enclosing at least one input element of an initial block section (also called initial block). This selection gesture causes selection of each input element contained (totally or at least partially) within the selection area.

The selection gesture may be a free-selection gesture (or lasso gesture) on the input surface 4. This selection gesture may form a closed (or nearly closed) loop (or path), such as a roughly circular or oval form or the like, or at least a geometric shape which allows the computing device to deduce therefrom the selection area which may contain one or more input elements. In response to the detection of this selection gesture, a visual indication may be displayed on the display, thereby rendering the user with visual feedback of the detection.

The input selection module 16 is configured to select the at least one input element enclosed (totally or partially) within (or by) the selection area, said at least one input element being positioned at an initial location within the initial block section.

In a particular example, each input element at least partially enclosed or included in the selection area is selected. As a result, a selection, defined by the input selection module 16, may include at least one input element of the initial block section while excluding at least one other input element (or each other block) of that same initial block which are not enclosed (totally or partially) within the section area.

In one embodiment, the at least one enclosed input element includes text as digital ink. In another embodiment, the at least one enclosed input element includes text as typeset content.

In one embodiment, the input selection module 16 is configured such that each input element completely enclosed within the selection area and each input element only partially enclosed within the selection area are recognized by the computing device as at least one selected input element.

In a particular embodiment, an algorithm may be executed by the computing device DV, for each input element only partially enclosed in the selection area, to determine the proportion (or percentage) of the input element within (or conversely outside) the selection area and to deduce therefrom whether the input element is included in the selection. For instance, a partially enclosed input element may be recognized as part of the selection if the relative proportion of the one or more strokes of the input element enclosed within the selection area reaches a predetermined threshold.

Alternatively, the input selection module 16 may be configured such that only the input elements which are completely enclosed within the selection area are recognized as being selected.

In the present embodiment, the input selection module 16 is configured such that the selection gesture causes generation by the computing device DV of a stroke of digital ink on the display device. In other words, a digital ink stroke is displayed by the display 5 along the path of the user selection gesture thereby rendering the user with visual feedback of the detection. This stroke can be displayed in real-time while the user is hand-drawing the selection area with the input surface.

The skilled person may however contemplate other implementations where other forms of gesture are used.

The displacement module 18 is configured, in response to a moving gesture or dragging gesture detected with (or on) the input interface 4, to move the at least one selected input element from the initial location to a final location positioned outside the 10 initial text block section. To this end, the displacement module 18 may detect the moving (or dragging) gesture and move the at least one selected input element according to said moving gesture. This moving gesture or dragging gesture thus causes a displacement of the selected input element(s), also referred to as the selection, from the selection initial location positioned within the initial block section to the final location positioned outside the initial block.

A location of the selected input element(s) may be defined according to a reference point. The coordinates (x, y) of this reference point may be defined on a bounding box defined by the HWR system around the extend of the selected input element(s). The initial location of an input element may be defined by the coordinates of the reference point of the bounding box of said input element before the occurrence of the moving gesture.

The reference point of the bounding box enclosing the input elements of the block section may be, for example, the upper left corner of the enclosing bounding box.

Therefore, the selection initial location and the final location may be identified by the coordinates of the upper left corner of the bounding box of the selected input elements in the initial block section, wherein the final location is calculated by moving the bounding box according to the displacement caused by the moving (or dragging) gesture.

The moving gesture defines the displacement. The displacement module 18 may be configured to detect a direction and a distance of the displacement between a pointer initial position and a pointer final position detected through the moving gesture made by the user over the display.

The new block creation module 20 is configured to create a new block section (or new block) at the final location. The new block section encloses the at least one selected input element of the initial block section.

In a particular example, the final location of the bounding box of the selected input elements is calculated based on the displacement of the at least one selected input element from the initial location to the final location.

In one embodiment, the new block section is defined according to the bounding box of the selected input element(s).

In another embodiment, following the displacement of the selected input elements, the HWR system may perform handwriting recognition of the at least one selected input element at the final location in combination with existing content positioned in the surrounding of the final location. The existing content positioned nearby the displaced input element(s) originated from the initial block section may be combined with the selection, this combination being interpreted by the HWR system as new content. This new content may be recognized as modified input element and enclosed in a modified bounding box.

Any unselected input element may remain at a respective static initial location according to different configurations as explained below.

In one embodiment where a plurality of input element are not selected, the unselected input elements may form one continuous block of unselected input elements.

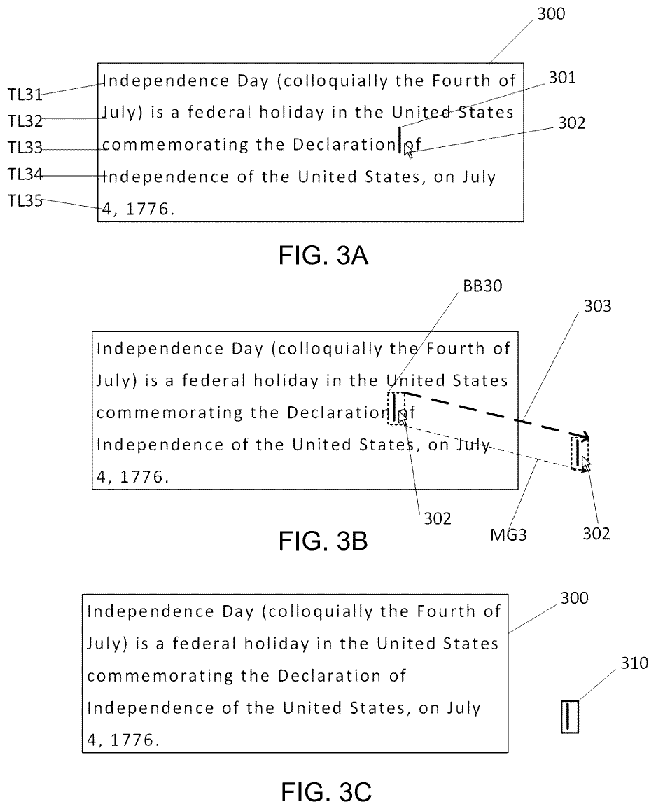

In a first example further detailed in FIG. 3, the selected input element is a cursor. The unselected input elements remain as a continuous block being the initial block section. Therefore, in this first example, the unselected input elements remain in the initial block section at a static initial location, e.g the initial location of the bounding box of the unselected input element.

In a second example wherein the selected input element(s) are selected as one upper or one lower portion of the initial block section, the unselected input element(s) constitute a (at least one) remaining block of the initial block section. Consequently, the initial block section may be adjusted (or converted), by an initial block adjustment module 22, to (or into) the remaining block enclosing the unselected input element(s), such that the adjusted initial block section corresponds to a bounding box of the unselected input element(s).

In other words, in response to the displacement of the selected input element(s), the initial block section is separated into the new block section at the final location along with at least one adjusted initial block section comprising each unselected input element, where said at least one adjusted initial block section remains at a static location, i.e. the initial position of the initial block section.

If the unselected input element(s) are positioned above the selected input element(s), the upper left corner of the remaining block is the upper left corner of the initial block section. If the unselected input element(s) are positioned below the selected input element(s), the upper left corner of the remaining block is the upper left corner of the bounding box of the unselected input element(s).

In another embodiment wherein the selected input element(s) are selected as a middle portion of the initial block section, the unselected input element(s) are broken up in two remaining blocks enclosing a first group and a second group of unselected input element(s) as an upper portion and a lower portion of the initial block section, respectively.

The first group of unselected elements remains enclosed in the upper portion of the initial block section adjusted by the initial block adjustment module 22 and a second group of unselected elements is enclosed in a second new block section created by a subsequent block creation module 24.

The first group of the unselected input element(s) is positioned above or at a left-hand side of the selected input element(s); therefore, the first unselected input element(s) remain in the initial block section at a first static initial location wherein the initial block section is shortened to be adjusted to a first bounding box the first unselected elements.

A second group of the unselected input element(s) is positioned below or at a right-hand side of the selected input element(s); therefore, the second unselected input element(s) are enclosed in a second new block section. The second new block section is created at a second static initial location defined at the upper left corner of a second bounding box of the second unselected elements.

The present system and method advantageously allow to manually correct an existing block that does not match the intention of the user, either because the text input elements are not recognized as expected or because block creation by other existing method leads to mistaken selection of the input text elements. The present system and method allow to separate, quickly and efficiently, mismatched content with simple and intuitive gestures and improve handwritten recognition outcome by transforming the linguistic context of the rearranged text blocks. Modification of the linguistic context of recognition may lead to different probabilistic scores of the word candidates and better handwritten recognition accuracy, as further exemplified below.

FIGS. 2A, 2B, 2C and 2D show an example of a method implemented by the computing device DV for creating a new block section according to a particular embodiment of the invention. To this end, the processor 6 of the computing device may execute the application 12 (FIG. 1). FIG. 2A shows, on the input surface 4, an initial block section (also called initial block) 200 enclosing input elements including nine text lines—noted TL21 to TL29, on the display area 5 of the computing device DV.

Additionally, FIG. 2A shows a first path 205 defines a selection area which surrounds the fourth, fifth and sixth text lines—noted TL24, TL25 and TL26 respectively-of the initial block section 200. This selection area is detected as part of a detection step based on a first user selection gesture SG1. These text lines TL24, TL25 and TL26 are thus selected, as part of a selection step, at an initial location (or initial position) within the initial text block section 200.

More specifically, in the present example, this first path 205 is defined by a movement of a pointer 201 according to a first selection gesture SG1. This first selection gesture SG1 is recognized by the computing device DV as a selection of the input elements, i.e. TL24, TL25 and TL26 in the present example.

Following the first selection gesture SG1, FIG. 2B shows the nine text lines TL of FIG. 2A at their initial locations and three bounding boxes BB21, BB22, BB23. The bounding box BB2 encloses the selected input elements TL24, TL25 and TL26. In the present example, the bounding box BB21 is adjusted to enclose a first group of unselected input elements TL21, TL22 and TL23. The bounding box BB23 encloses a second group of unselected input elements TL27, TL28, TL29. The bounding boxes

BB21, BB22, BB23 are defined according to perimeters of their respective enclosed input elements.

In a particular example, a visual indication of the first path 205 is displayed (FIG. 2B).

As shown in FIG. 2B, a moving (or dragging) gesture MG1 may be detected with the input surface 4. More specifically, a second pointer 202 may be displayed at an initial position (or initial location) of the moving gesture MG1 for moving the selected elements TL24, TL25 and TL26 from an initial location to a final location. Accordingly, the selected elements TL24-TL26 are moved as part of a moving step in response to the selection gesture SG1 (see FIG. 2C).

The moving gesture MG1 may define a displacement move characterized by a displacement direction and a displacement distance as illustrated by a dash arrow 206 (FIG. 2B) between the initial point and a final point of the pointer 202.

FIG. 2C shows, on the display 5 (e.g. in the input surface 4), the bounding boxes BB21, BB22 and BB23 enclosing their respective text lines TL24, TL25 and TL26 as previously selected in the selection step.

The second bounding box BB22 enclosing the three selected text lines TL24, TL25 and TL26 is moved according to the moving gesture MG1, causing these text lines TL24-TL26 to be positioned at the final position defined by the displacement move 206. The displacement move 206, which may be applied to a reference point such as the upper left corner of the bounding box BB22, is represented by a dashed arrow 207 (FIG. 2C).

As shown in FIG. 2C, the selected text lines TL24-TL26 are moved according to the moving gesture MG1 independently of each unselected text line TL, i.e. independently of the text lines TL21-TL23 and TL27-TL29 which were not selected in the selecting step. This means that each unselected text line TL are not affected by the moving gesture MG1 and thus remains at their initial position.

More specifically, the first bounding box BB21, enclosing the first group of unselected input elements of the initial block section 200, including the first three text lines TL21, TL22 and TL23, remains at a first static initial position.

The third bounding box BB23 enclosing the second group of unselected input elements of the initial block section 200, including the last three text lines TL27, TL28 and TL29, is located at a second static initial position defined, for example, by the upper left corner of a bounding.

FIG. 2D shows, on the input surface 4 (or display 5), the result of above process of the first selection gesture SG1 and the first moving gesture MG1. A new text block section 220 is created, at the final location defined by the moving gesture MG1, this new text block section enclosing the three selected text lines TL24-TL26.

In a particular example, in response to the displacement move of each selected input element (i.e. TL24-TL26 in this example) caused by the moving gesture MG1, the initial block section 200 is separated (or rearranged) into the new block section 220 at the final location along with at least one adjusted block section—called adjusted initial block section—comprising each unselected input element, where each unselected input element remains at a static position independently of the displacement move.

More specifically, in this example, three block sections 210, 220 and 230 are displayed, corresponding respectively to the groups TL21-TL23, TL24-TL26 and TL27-TL29.

The first new block section 220 is located at the final position defined by the displacement move 206. The first new block section 220 enclosing (or comprising) the selected element TL24, TL25 and TL26 may be created upon completion of the moving gesture MG1 according to the bounding box BB22.

The other block sections 210 and 230, corresponding to the remaining block sections of the first and second group of unselected input elements, are located (and remained) at their first and second static initial locations, respectively, independently of the moving gesture MG1. These block sections 210 and 230 may be adjusted as appropriate.

The block sections 210 230 may look like remaining block sections of the initial block section 200 of FIG. 2A following partial selection and partial displacement of the initial block section 200.

FIGS. 3A, 3B and 3C show another example of a method implemented by the computing device DV for creating a new block section according to a particular embodiment of the invention. FIG. 3A shows, on the display 5 of the computing device DV, an initial block section 300 enclosing (or comprising) five text lines—noted TL31 to TL35—as input elements. Additionally, FIG. 3A shows a displayed cursor 301 within the third text line of the initial block section. The cursor 301 may allow for instance a user to enter additional typeset input elements. A pointer 302 is shown and illustrates a selection, by the user, of the cursor as the selected input element.

FIG. 3B shows the initial block section 300 including the five text lines and the selected cursor. A bounding box BB30 is represented and enclosing the selected cursor 301. The pointer 302 is displayed at an initial position of a moving gesture MG3 for moving the selected cursor from a selection initial location to a final position outside the initial block section 300. The selection of the cursor 301 by the pointer 302 is recognized (or detected) by the computing device.

The moving gesture MG3 may define a displacement move characterized by a displacement direction and a displacement distance illustrated by a dash arrow 303 between the initial position 302a and a final position 302b of the pointer.

FIG. 3C shows, on the input surface 4 (or display 5), two block sections 300 and 310 as a result of the moving gesture MG3. The new block section 310 is located at the final position defined by the displacement move. The initial block section 300 is located at the static initial location enclosing whole the initial input elements as unselected input elements; therefore, the whole of the unselected input elements remains in the initial block section at the initial location.

The cursor is displayed in a new block section 310 at the final position deduced from the enclosing bounding box BB30.

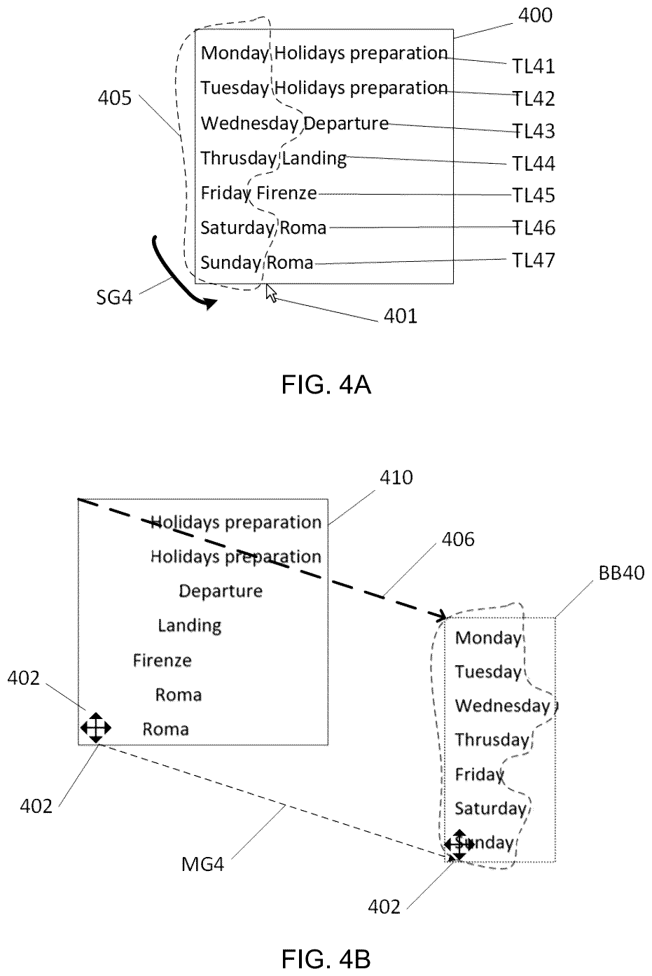

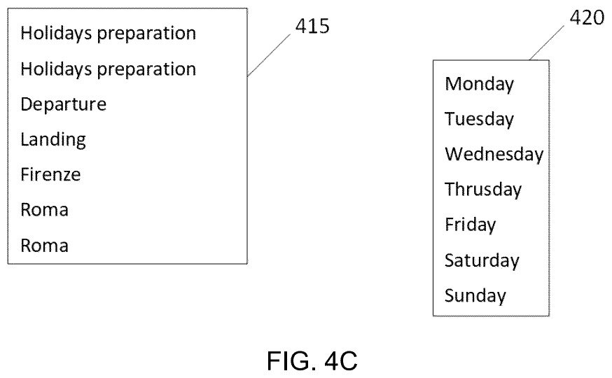

FIGS. 4A, 4B and 4C show another example of a method implemented by the computing device DV for creating a new block section according to a particular embodiment of the invention. FIG. 4A shows, on the display 5 of the computing device DV, an initial block section 400 enclosing (or comprising) seven text lines—noted TL41 to TL47—as initial input elements.

Additionally, FIG. 4A shows a pointer 401 that is moved along a path 405 to define a selection area which surrounds the first (initial) words of respectively seven text lines of the initial block section. A visual indication of the first path 405 may be displayed. The first pointer 401 is moved along the path 405 according to a selection gesture SG4, this gesture being recognized by the computing device DV as a selection of seven partial lines (portions of the seven text lines) of the initial block section 400 as the selected input elements.

FIG. 4B shows the initial block section with modified content 410 following a moving gesture MG4, detailed below. The selected input elements of the initial block section 400 are represented in a bounding box BB40.

The initial block section with modified content 410 encloses (or comprises) the unselected input elements resulting in seven remaining partial lines of the initial block section 400. The unselected elements include the remaining partial lines displayed in a same layout as the initial block section 400 of the FIG. 4A. The modified content of the initial block section 410 is not reflowed as long as the moving gesture MG4 is not finalized.

Additionally, a second pointer 402 is displayed at an initial point of the moving gesture MG4 for moving the selected elements from a selection initial location to a final position. The moving gesture MG4 defines a displacement move characterized by a displacement direction and a displacement distance illustrated by a dash arrow between the initial point and a final point of the pointer.

The selected elements are relocated at the final position defined by the displacement move. The displacement move applied to a reference point such as the upper left corner of the bounding box BB40 is represented by a dashed arrow 406.

FIG. 4C shows, on the input surface 4, two block section 415 and 420 created in response to the moving gesture MG4.

The new block section 420, enclosing the selected elements, is created according to the bounding box BB40 (FIG. 4B) located at the final position defined by the displacement move.

An adjusted initial block section 415, enclosing the unselected elements, remains at the static initial position of the initial block section 400. The unselected elements are left-aligned such that the remaining partial lines are aligned at a left border of the adjusted initial block section 415. Reflowing the unselected elements of the initial text block may happen when finalizing the moving gesture MG4, when releasing the second pointer 402.

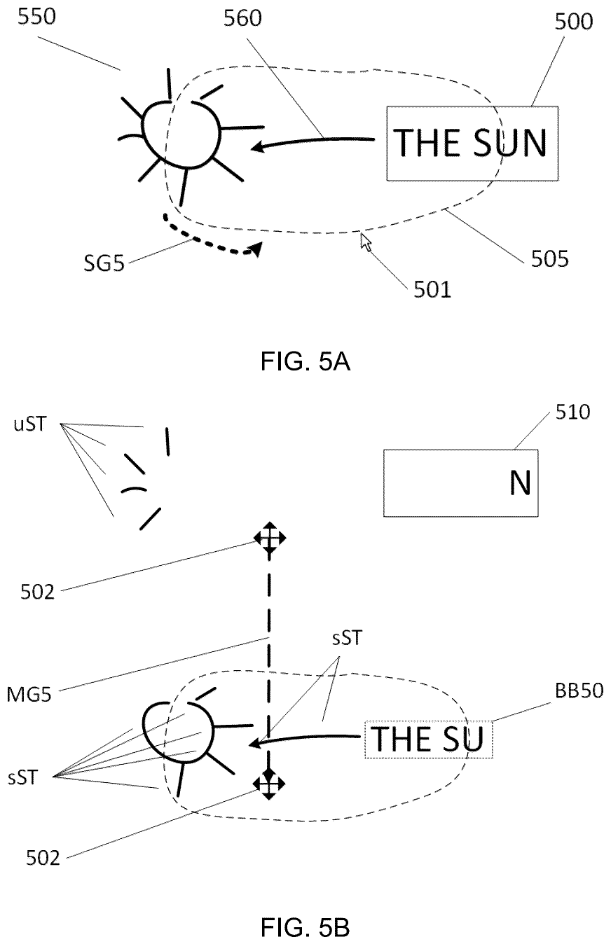

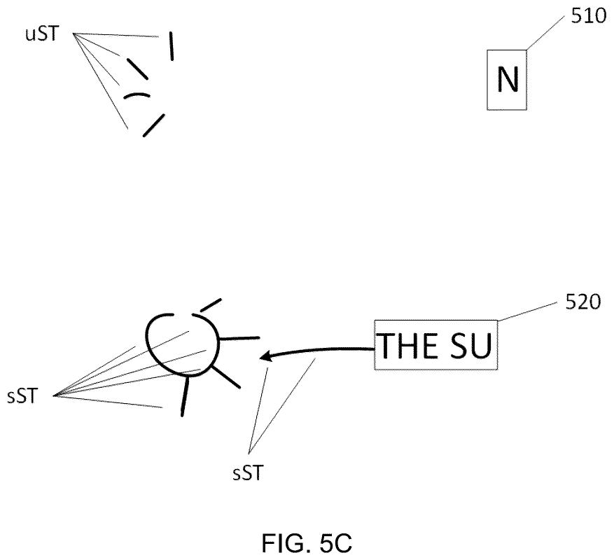

FIGS. 5A, 5B and 5C show another example of a method implemented by the computing device DV for creating a new block section according to a particular embodiment of the invention. FIG. 5A shows, on the display of the computing device DV an initial content at an initial position, said initial content including an initial block section 500, a first non-text element 550 and a second non-text element 560. The initial block section 500 comprises text content, i.e. typeset words (“THE SUN”) in this example. The first non-text item 550 is a sketch of a sun composed of nine hand-drawn strokes and the second non-text item 560 is an arrow composed of two hand-drawn strokes. The nature, number and configuration of the text and non-text elements may vary depending on each case.

FIG. 5A shows a pointer 501 moving along a path 505 which defines a selection area. The first pointer 501 moves along the path 505 according to a selection gesture SG5, this gesture being recognized by the computing device DV. A visual indication of the first path 505 may be displayed.

The selection area encloses the arrow 560 and encompasses partially the initial block section 500 and the sketch 550.

The selection area encloses the first word “THE” of the initial block section 500. The path 505 intersects the second word “SUN” of the initial block section 500 such that the first letter ‘S’ of the second word is enclosed in the selection area while the second letter ‘U’ of the second word is partially enclosed in the selection area.

The path 505 intersects the hand-drawn sketch 550 such that four strokes are enclosed in the selection aera.

The selection may be performed according to different modes, such as stroke-level selection, or object-level selection, objects may be characters, words, lines or shapes.

In one embodiment, the selection mode is at stroke-level, wherein a character, displayed as handwritten or typeset character, is treated as a stroke, whether partially or entirely enclosed in the selected area. In another embodiment, the selection mode is at object level, wherein a character, a word or a text-line, as well as a recognized shape is treated as an object, whether partially or entirely enclosed in the selected area.

In a particular embodiment, the selection is performed such that each stroke or object, depending on the selection mode, which is at least partially contained (whatever the relative proportion thereof) in the current selection area is included as part of the selection.

In another embodiment, selection is performed such that each stroke or object, depending on the selection mode, which presents a relative proportion within the selection area exceeding a predetermined threshold is selected. For instance, each stroke having at least 20%, or 50%, positioned inside the current selection area is included as part of the selection. In this case, if only a relative small portion of a stroke, below the predetermined threshold, is positioned within the selection area, then the stroke is not included in the selection.

In FIG. 5B wherein the selection mode is at stroke-level, the selection area defines the selected input elements as a portion of the initial block section 500 which includes the first word “THE” and the two first letters of the second word “SU”. Additionally, the selection area encloses the second non-text item 560 and a part of the non-text item 550 which includes the four enclosed strokes of the first non-text item 550. The enclosed strokes of the first and second non-text items 550 and 560 are also referred to as the selected strokes sST (FIG. 5B).

FIG. 5B shows the content of FIG. 5A rearranged according to a moving gesture MG5. The selected input elements of the initial block section 500 are represented in a bounding box BB50. The selected input elements are moved at a final position according to the displacement (or displacement move) defined by the moving gesture MG5.

The selected strokes sST include the enclosed five strokes from the hand-drawn sketch, the enclosed arrow 560, the enclosed first word “THE” and the enclosed first two letters “SU” from the second word of the initial block section 500. The selected strokes sST are moved at a final position according to the displacement.

The unselected input elements include the unselected letter “N” from the second word of the initial block section 500 enclosed in a bounding box BB50. The unselected elements are displayed (or remain) in an identical layout as the initial content of the FIG. 5A at respective static initial positions, that is, independently of the displacement of the selected input elements. The unselected strokes uST (FIG. 5B) include four strokes of the first non-text item. The unselected strokes uST are displayed (or remain) in an identical layout as the initial content of the FIG. 5A at respective static initial positions.

A second pointer 502 (FIG. 5B) may be displayed at an initiation point of the moving gesture MG5 from a first initial location 502a to a final position 502b.

The moving gesture MG5 (FIG. 5A) may define a displacement move characterized by a displacement direction and a displacement distance illustrated by a dash arrow of MG5 between the initiation point 502a and a final point 502b of the pointer.

The selected content, including the selected input elements and the selected strokes, are moved to respective final positions defined by the displacement move MG5. The displacement move may be applied to each point of the selected content from the initial location to the final position.

FIG. 5C shows, on the input surface 4, the initial block section with modified content 510 enclosing the unselected letters, and a new block section 520 enclosing the selected letters including the first word and the first two letters from the second word of the initial block section 500.

The modified initial block section 510 remains at the static initial point.

The new block section 520 is located at the final position defined by the displacement move MG5.

Additionally, FIG. 5C shows the unselected strokes at respective initial static positions and the selected strokes at respective final positions.

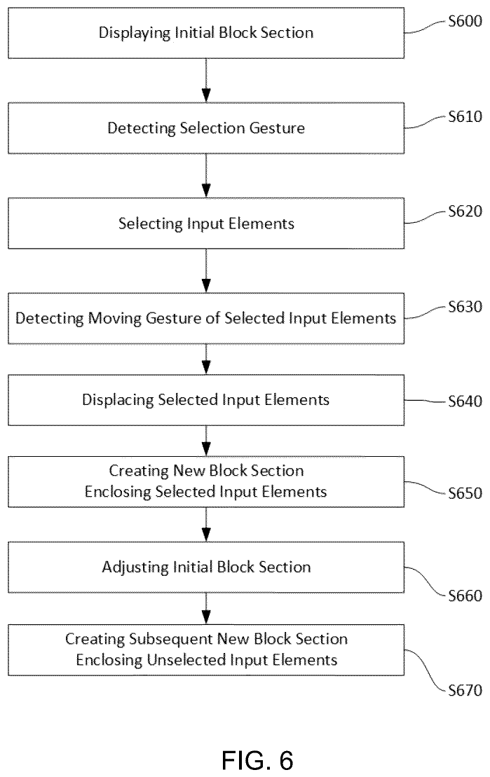

A method implemented by the computing device DV (as described earlier with reference notably to FIG. 1-5) for creating, on a display, block sections enclosing input elements obtained from an initial block section is now described with reference to FIG. 6, in accordance with a particular embodiment of the present invention. More specifically, the computing device DV implements this method by executing the application 12 stored in the memory 7. The steps of the method in the present example may be applied to any of the particular embodiments described earlier with reference to FIG. 2-5.

In a displaying step S600, the computing device DV displays an initial block section on a display. The initial block section may include input elements hand-drawn and/or typeset by a user using an appropriate user interface.

Input elements may comprise text handwriting, diagrams, musical annotations, and so on. Each of these elements may be formed by one or more strokes of digital ink. As mentioned earlier, handwriting recognition may be performed on text input elements. Handwriting recognition may also be performed on non-text input elements. In addition, each input element may be converted and displayed as typeset input elements, as depicted in the examples of FIGS. 2, 3, 4 and 5. Text elements may include characters, word or text-lines.

In a selection gesture detecting step S610, the computing device DV detects a user selection gesture performed with the input surface 4 to define a selection area (also called lasso enclosure). In other words, the computing device DV detects initiation of a user selection gesture performed by a user with the input surface 4 to define a selection area.

The user selection gesture may be any interaction of a user's body part (or any input tool) with the input surface 4 which causes definition of a selection path. This user interaction may also cause generation of a stroke of digital ink on the display device along the selection path. Display (if any) of this digital ink advantageously provides visual feedback to assist the user while he/she is drawing a selection path in the display area.

In an input element selecting step S620, the computing device DV selects each input element enclosed at least partially within the selection area determined in S610. At least one input element is thus selected, the at least one selected input element being positioned at an initial location within the initial text block section.

The computing device DV may identify, and select, dynamically which input element(s) is/are positioned at least partially within the selection area while the user selection gesture is being performed. The user selection gesture thus results in selecting each input element encircled at least partially in the selection area.

In the example depicted in FIG. 5, the computing device may detect that a portion of the input elements is positioned within the selection area and thus identify which input elements are part of a selection.

In a particular example, each input element which is at least partially contained (whatever the relative proportion thereof) in the current selection area is included as part of the selection.

In a particular example, selection is performed in S620 such that each input element which presents a relative proportion within the selection area exceeding a predetermined threshold is selected. For instance, each input element having at least 20%, or 50%, positioned inside the current selection area is included as part of the selection. In this case, if only a relative small portion of an input element, below the predetermined threshold, is positioned within the selection area, then the input element is not included in the selection.

In a moving gesture detecting step S630, the computing device detects a moving gesture (or user dragging gesture) with the input interface 4. This moving gesture defines a displacement movement of the selected input elements.

A user moving gesture, for example a long tap-and-slide on the interface surface 4 of the computing device over the selected input elements, is detected as a moving gesture of the selected input elements.

During this moving gesture detecting step S630, each selected input element may be decoupled from the initial block section. As part of the moving gesture detecting step S630, specific visual feedback may be displayed to guide interaction with the input elements. In the example depicted in FIGS. 2, 3, 4 and 5, the user moving gesture moves from the initial point located in the initial block section to a final point located outside the perimeter of the initial block section. In response thereto, the computing device DV defines a displacement to be performed on each selected input elements outside of the block section, as described further below.

In an input element displacing step S640, the computing device DV moves the at least one input element selected in S620 from a selection initial location (or position) positioned within the initial block section to a final location (or final position) positioned outside the initial block. The displacement (or displacement move) of each selected input element is thus performed according to the user moving gesture.

The move operated in S640 may be a displacement including a direction and a distance of the displacement. The direction and the distance may be determined based on the user moving gesture, for instance based on a pointer which is detected in S630 as moving from a pointer initial position to a pointer final position according to the user moving gesture. The direction and distance may for instance be determined based on the pointer initial position of the pointer final position.

The displacement in S640 is applied to the each selected input element. A location of the selected input elements may be defined according to a reference point and coordinates (x, y) of the reference point defined on a bounding box, determined by the HWR system, around the extend of the selected input elements. The initial location of an input element is defined by the coordinates of the reference point of the bounding box of said input element before the occurrence of the moving gesture.

The reference point of the bounding box enclosing the input elements of the block section may be, for example, the upper left corner of the enclosing bounding box.

Therefore, the selection initial location and the final position may be identified by the coordinates of the upper left corner of the bounding box of the selected input elements in the initial block section, wherein the final position is calculated by moving the bounding box according to a displacement.

In a new block section creating step S650, the computing device creates (or generated) a new block section enclosing (or comprising) each selected input element moved in S640 from the initial point within the initial block section to the final point outside of the initial block section.

In a particular example, releasing the selected input elements at a position located outside the perimeter of the bounding box of the initial text block finalizes the moving gesture and validate the final position. The release of the selected input elements may for instance trigger the creation S650 of the new block section defined according to the bounding box of the selected input elements. The new block section is created at the final position.

In another embodiment, following the displacement S640 of the selected input elements, the HWR system may perform further recognition of the selected input elements at the final location in combination with existing content positioned in the surrounding of the final location. The existing content positioned nearby the displaced input elements originated from the initial block section may be combined with the selection, this combination being interpreted by the HWR system as new content. This new content may be recognized as modified input element and enclosed in a modified bounding box.

Additional steps S660 and/or S670 may be performed as described further below, although other embodiments without such steps are possible.

In an initial block adjusting step S660, the computing device may adjust the initial block section according to the unselected input elements remaining at static initial positions.

When the selected input elements are selected as one upper or one lower portion of the initial block section, the unselected input elements may constitute a remaining block of the initial block section. Consequently, the initial block section may be adjusted to the remaining block enclosing the unselected input elements, such that the adjusted initial block section corresponds to a bounding box of the unselected input elements.

If the unselected input elements are positioned above the selected input elements, the upper left corner of the remaining block may be the upper left corner of the initial block section. If the unselected input elements are positioned below the selected input elements, the upper left corner of the remaining block may be the upper left corner of the bounding box of the unselected input elements.

In a subsequent new block creating step S670, the computing device DV may create a subsequent new block section enclosing a second group of unselected input elements remaining at second static initial positions.

When the selected input elements are selected as a middle portion of the initial block section, the unselected input elements may be broken up in two remaining blocks enclosing a first group and the second group of unselected input elements as an upper portion and a lower portion of the initial block section, respectively.

The first group of unselected elements may remain enclosed in the upper portion of the initial block section adjusted at the initial block section adjusting step S660 and the second group of unselected elements may be enclosed in a subsequent new block section created as further explained below.

The first group of the unselected input elements may be positioned above or at a left- hand side of the selected input elements; therefore, the first group of unselected input elements may remain in the initial block section at first static initial locations wherein the initial block section may be shortened to be adjusted to a first bounding box the first unselected elements at the previous step S660.

The second group of the unselected input elements may be positioned below or at a right-hand side of the selected input elements; therefore, the second group of unselected input elements may be enclosed in the subsequent new block section. The subsequent new block section may be created at a second static initial location defined, for example, at the upper left corner of a second bounding box of the second unselected elements.

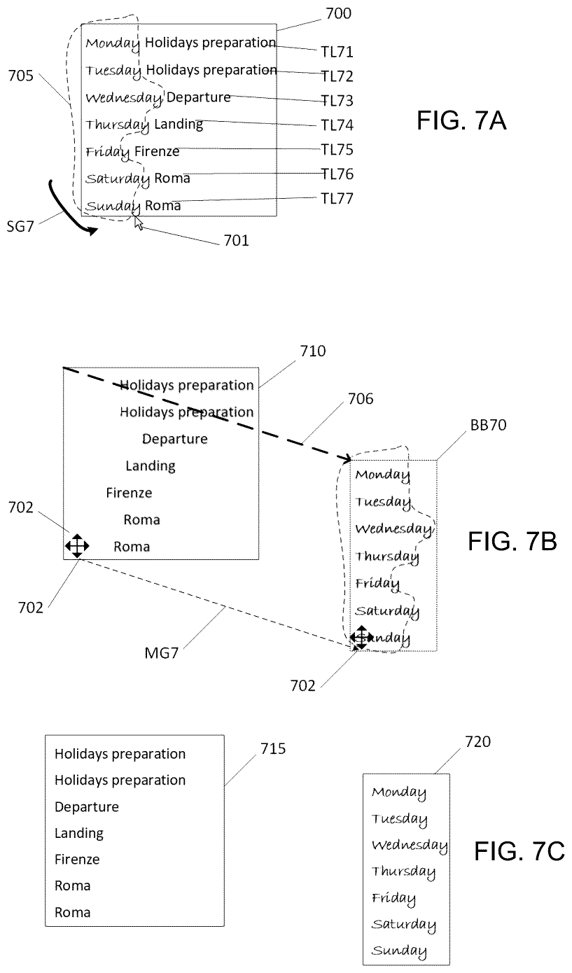

In another embodiment, in response to a new block section creation step (S650/S670), the computing device may cause re-recognition of selected handwritten input text within said new text block, of a first group of unselected handwritten input text within the initial text block and of a second group of unselected input elements within the subsequent new text block. FIGS. 7A, 7B and 7C show an example of a method implemented by the computing device DV for creating a new block section according to a particular embodiment of the invention. FIG. 7A shows, on the display 5 of the computing device DV, an initial block section 700 enclosing (or comprising) seven text lines—noted TL71 to TL77—as initial input elements. Each text line comprises mix type input elements including handwritten input elements and typeset input elements. For example, the first line TL71 is composed of a handwritten input word (“Monday”) and typeset input elements

(“Holidays preparation”). The computing device DV displays the plurality of input strokes of the handwriting input elements. The user may input content as handwritten input elements, the computing device may perform the handwritten input recognition, thus the handwritten input elements may be converted and displayed as typeset input elements. In one example, the seven text lines TL71 to TL77 are handwritten by the user (not shown), the computing device performs the text block extraction of the initial block 700 including the handwriting recognition of the seven text lines TL71 to TL77. The user may trigger the partial conversion of the text lines wherein the seven first word of each lines are displayed as handwritten input and the second and following words of each line are converted and displayed as typeset elements as shown on FIG. 7A.

Additionally, FIG. 7A shows a pointer 701 that is moved along a path 705 to define a selection area which surrounds the first (initial) handwritten words of respectively seven text lines of the initial block section. A visual indication of the first path 705 may be displayed. The first pointer 701 is moved along the path 705 according to a selection gesture SG7, this gesture being recognized by the computing device DV as a selection of seven partial lines (portions of the seven text lines) of the initial block section 700 as the selected handwritten input elements.

FIG. 7B shows the initial block section with modified content 710 following a moving gesture MG7, detailed below. The selected handwritten input elements of the initial block section 700 are represented in a bounding box BB70.

The initial block section with modified content 710 encloses (or comprises) the unselected input elements resulting in seven remaining partial lines of the initial block section 700. The unselected elements include the remaining partial lines displayed in a same layout as the initial block section 700 of the FIG. 7A. The modified content of the initial block section 710 is not reflowed as long as the moving gesture MG7 is not finalized.

Additionally, a second pointer 702 is displayed at an initial point of the moving gesture MG7 for moving the selected elements from a selection initial location to a final position. The moving gesture MG7 defines a displacement move characterized by a displacement direction and a displacement distance illustrated by a dash arrow between the initial point and a final point of the pointer.

The handwritten selected elements are relocated at the final position defined by the displacement move. The displacement move applied to a reference point such as the upper left corner of the bounding box BB70 is represented by a dashed arrow 706.

FIG. 7C shows, on the input surface 4, two block section 715 and 720 created in response to the moving gesture MG7.

The new block section 720, enclosing the handwritten selected elements, is created according to the bounding box BB70 (FIG. 7B) located at the final position defined by the displacement move.

An adjusted initial block section 715, enclosing the unselected elements, remains at the static initial position of the initial block section 700. The unselected elements are left-aligned such that the remaining partial lines are aligned at a left border of the adjusted initial block section 715. Reflowing the unselected elements of the initial text block may happen when finalizing the moving gesture MG7, when releasing the second pointer 702.

Additionally, the creation of the new text block 720, the handwritten selected elements are re-recognized. The re-recognition of the selected input text may result in different converted outcomes compared to the recognized initial handwritten input text. Because the creation of the new text blocks redefines the linguistic context. The re-recognition process may modify the probabilistic scores of the word candidates processed compared to the recognition process.

The re-recognition improves the accuracy of handwritten recognition by allowing the initial handwritten input to be efficiently fragmented and by recovering a more representative linguistic context.

The re-recognition process may also be performed on handwritten unselected input elements within the remaining block and/or the subsequent new block.

Rearranging text block sections of handwriting input text allows improved processing of the input text handwriting recognition.

1. A computer implemented method for creating, on a display, a new text block section, said method comprising:
displaying, on the display, an initial text block section;
detecting, with an input interface, a user selection gesture defining a selection area enclosing at least one input element of the initial text block section;
selecting the at least one enclosed input element positioned at an initial location within the initial text block section;
moving, in response to a user dragging gesture detected with the input interface, the at least one selected input element from the initial location to a final location positioned outside the initial text block section; and
creating at the final location the new text block section enclosing the at least one selected input element.

2. A method of claim 1, wherein the at least one input element is a character, a word or a text line.

3. A method of claim 1, wherein the at least one selected input element includes at least one text line whereby the at least one text line is aligned with a border of the new block section.

4. A method of claim 1, comprising:
in response to the user dragging gesture, at release of the at least one selected input element, resizing the initial text block section, to enclose at least one first unselected input element of the initial text block section.

5. A method of claim 1, comprising creating a subsequent block section to enclose at least one second unselected input element of the initial text block section.

6. A method of claim 5, wherein the first or second unselected elements include text lines whereby the first or second unselected elements are aligned with a border of the initial and the subsequent new block section, respectively.

7. A method of claim 1, wherein the input elements enclosed in the initial text block section are handwritten input, said method further comprising:
recognizing the handwritten input elements;

8. A method of claim 7 comprising, in response to the creating of the new text block section:
re-recognizing the handwritten input elements including the at least one selected input element and the at least first and second unselected input element;

9. A method of claim 8, wherein the at least one selected input element and the at least first and second unselected input element are converted as typeset.

10. A method of claim 1, wherein the selection area encloses an image.

11. A method of claim 1, wherein the selection area encloses at least one non-text stroke.

12. A method of claim 1, wherein the at least one selected input element is a cursor.

13. A computing device for creating a new text block section enclosing input elements obtained from an initial text block section, comprising:
a display area configured to display the initial text block section and the new text block section;
an input area configured to detect:
a user selection gesture defining a selection area enclosing at least one input element of the initial text block section;
a user dragging gesture for moving the at least one selected input element from the initial text block section to a final location positioned outside the initial text block section;
a input selection module configured to select the at least one enclosed input element positioned at an initial location within the initial text block section;
a displacing module configured to move the at least one selected input element from the initial text block section to a final location positioned outside the initial text block section;
a new block creation module configured to create the new text block section at the final position enclosing the at least one selected input element.

14. A computing device of claim 13 further comprising:
an initial block adjusting module configured to adjust the initial text block section, to enclose at least one first unselected input element of the initial text block section.

15. A computing device of claim 13 further comprising:
a subsequent block creation module configured to create a subsequent block section, to enclose at least one second unselected input element of the initial text block section.
